(19) United States
(12) Patent Application Publication
(10) Pub. No.: US 2026/0142730 A1
(43) Pub. Date: May 21, 2026

(54) OPTICAL TRANSMISSION SYSTEM AND TRANSMITTER

(71) Applicant: Fujitsu Limited, Kawasaki-shi (JP)

(72) Inventors: Hisao NAKASHIMA, Kawasaki (JP); Guoxiu HUANG, Kawasaki (JP); Yo NAKAMURA, Yokohama (JP)

(73) Assignee: Fujitsu Limited, Kawasaki-shi (JP)

(21) Appl. No.: 19/388,252

(22) Filed: Nov. 13, 2025

(30) Foreign Application Priority Data
Nov. 15, 2024 (JP) 2024-199795

(51) Int. Cl. H04B 10/58

(52) U.S. Cl. CPC H04B 10/58

(57) ABSTRACT

An optical transmission system includes a transmitter and a receiver. The transmitter includes a generator that generates a second digital signal including a first digital signal and a third signal, the first digital signal including a first signal corresponding to a pilot symbol and a second signal corresponding to a data signal, the third signal including information related to a carrier phase of the first signal after Tomlinson-Harashima Precoding (THP) processing is performed, a THP processor that performs the THP processing on the second digital signal, and a transmission circuit that transmits, to the transmission line, signal light generated based on a third digital signal. The receiver includes a reception circuit that receives the signal light from the transmission line, and a compensator that compensates for an error of the second signal based on the first signal and the third signal included in the third digital signal.

### CROSS-REFERENCE TO RELATED APPLICATION

This application is based upon and claims the benefit of priority of Japanese Patent Application No. 2024-199795 filed on November 15, 2024, the entire contents of which are incorporated herein by reference.

### FIELD

A certain aspect of the present embodiments relates to an optical transmission system and a transmitter.

### BACKGROUND

In an optical transmitter that modulates and demodulates an optical signal using a signal processing technique, a pilot symbol as a known signal may be inserted into a data signal by a signal processing unit on a transmission side in order to perform signal processing on a reception side with high accuracy and in a simple manner. In order to make signal processing highly accurate and simple, the pilot symbol is often generated by a modulation method with a small number of signal points. For example, the pilot symbol is generated by a modulation method called QPSK (Quadrature Phase Shift Keying) that transmits 2-bit data using four signal points.

The optical transmitter may process the signal by Tomlinson-Harashima Precoding (THP) processing for suppressing inter-symbol interference. When the optical transmitter processes a signal by the THP processing, if a pilot symbol is inserted into a data signal to be THP-processed, the THP processing is performed not only on the data signal but also on the pilot symbol. For example, when the THP processing is performed on the pilot symbol whose modulation method is the QPSK, each pilot symbol is converted into any of 16 signal points, depending on the analog band of the transmission line and the data signals before and after the pilot symbol.

As described above, when the number of signal points of the pilot symbol increases due to the THP processing, the configuration of a circuit that performs polarization separation, estimation of transmission characteristics, and compensation for phase noise may become complicated in the optical receiver. From the viewpoint of avoiding such an increase in the number of signal points, there has been proposed a technique in which each pilot symbol is mapped to four signal points by making the amplitude of the pilot symbol the same as the amplitude of the modulo operation in the THP processing (see, for example, Japanese Patent Application Publication No. 2024-58713). It is known that the THP processing is used in the fields of optical fiber communication and wireless communication (see, for example, Japanese Patent Application Publication No. 2013-258694, Japanese Patent Application Publication No. 2009-182894, U.S. Patent Application Publication No. 2017/0310373, and U.S. Patent Application Publication No. 2001/0035997).

### SUMMARY

According to an aspect of the present disclosure, there is provided an optical transmission system comprising: a transmitter; and a receiver that receives signal light transmitted from the transmitter via a transmission line; wherein the transmitter includes: a generator that generates a second digital signal including a first digital signal and a third signal, the first digital signal including a first signal corresponding to a pilot symbol and a second signal corresponding to a data signal, the third signal including information related to a carrier phase of the first signal after Tomlinson-Harashima Precoding (THP) processing is performed; a THP processor that performs the THP processing on the second digital signal; and a transmission circuit that transmits, to the transmission line, signal light generated based on a third digital signal which is a signal after the THP processing is performed on the second digital signal; and wherein the receiver includes: a reception circuit that receives the signal light from the transmission line; and a compensator that compensates for an error of the second signal based on the first signal and the third signal, both of which are included in the third digital signal generated based on the signal light received by the reception circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of an optical network.

FIG. 2 illustrates an example of a functional configuration of a TxDSP.

FIG. 3A illustrates an example of a data symbol string input to a second insertion unit.

FIG. 3B illustrates an example of a data symbol string output from the second insertion unit.

FIG. 4A illustrates an example of a constellation map to which pilot symbols are mapped.

FIG. 4B illustrates an example of a constellation map to which phase information symbols before THP processing are mapped.

FIG. 5 illustrates an example of a constellation map to which phase information symbols after the THP processing are mapped.

FIG. 6 illustrates an example of a functional configuration of a CPR according to a first embodiment.

FIG. 7 illustrates an example of a reception symbol string input to the CPR.

FIG. 8A illustrates another example of a constellation map to which phase information symbols before the THP processing are mapped.

FIG. 8B illustrates another example of a constellation map to which phase information symbols after the THP processing are mapped.

FIG. 9A illustrates an example of a constellation map to which data symbols before the THP processing including phase information symbols are mapped.

FIG. 9B illustrates an example of a constellation map to which data symbols after the THP processing including phase information symbols are mapped.

FIG. 10 is a flowchart illustrating an example of the operation of the CPR according to the first embodiment.

FIG. 11 illustrates an example of a reception symbol string including a pilot symbol into which a phase information symbol is not inserted.

FIG. 12 illustrates an example of a circuit diagram of a THP processing unit.

FIG. 13A illustrates an example of a data symbol string input to the THP processing unit.

FIG. 13B illustrates an example of a data symbol string output from the THP processing unit.

FIG. 14A illustrates an example of a data symbol string in which a zero symbol is inserted for each cycle.

FIG. 14B illustrates an example of a data symbol string in which a zero symbol is inserted every two cycles.

FIG. 15A illustrates an example of a data symbol string in which a zero symbol is inserted for each period.

FIG. 15B illustrates an example of a data symbol string in which a zero symbol is inserted every three periods.

FIG. 16 illustrates an example of a reception symbol string including phase information symbols independent of pilot symbols.

FIG. 17 illustrates an example of a functional configuration of a CPR according to a third embodiment.

FIG. 18 illustrates an example of a reception symbol string that does not include a pilot symbol but includes a phase information symbol as a known signal.

FIG. 19 illustrates an example of a functional configuration of a CPR according to the fourth embodiment.

FIG. 20 illustrates an example of a reception symbol string that does not include a pilot symbol but includes a phase information symbol as a known signal.

FIG. 21 illustrates an example of a functional configuration of a CPR according to a fifth embodiment.

FIG. 22 illustrates an example of a constellation map illustrating a first zone, a second zone, and a third zone.

FIG. 23 is a flowchart illustrating an example of the operation of the CPR according to the fifth embodiment.

FIG. 24 illustrates another example of a functional configuration of a CPR according to the fifth embodiment.

FIG. 25 is a flowchart illustrating another example of the operation of the CPR according to the fifth embodiment.

### DESCRIPTION OF EMBODIMENTS

However, in the above-described technique, the pilot symbol is moved to any one of the four signal points by the modulo operation. That is, the pilot symbol may be moved to the original signal point, or may be moved to any of the remaining three signal points different from an original signal point. Such movement of the pilot symbol can be rephrased as corresponding to loss of information of the carrier phase of the pilot symbol.

If the information on the carrier phase of the pilot symbol is lost, the optical receiver cannot use the pilot symbol as a known signal, and may not be able to restore the carrier phase of the data signal. In such a case, it is assumed that the carrier phase of the data signal is restored using, for example, a Viterbi & Viterbi method (hereinafter referred to as a V & V method).

However, when the V & V method is used, a phase slip may occur in unwrap processing performed in the V & V method. The occurrence of the phase slip may induce a burst error, and the transmission quality in the optical transmission may be deteriorated.

Therefore, according to an aspect, it is desirable to provide an optical transmission system and a transmitter that transmit a signal for stably restoring a carrier phase of a signal on which the THP processing is performed.

Hereinafter, embodiments of the present disclosure will be described with reference to the drawings.

### First Embodiment

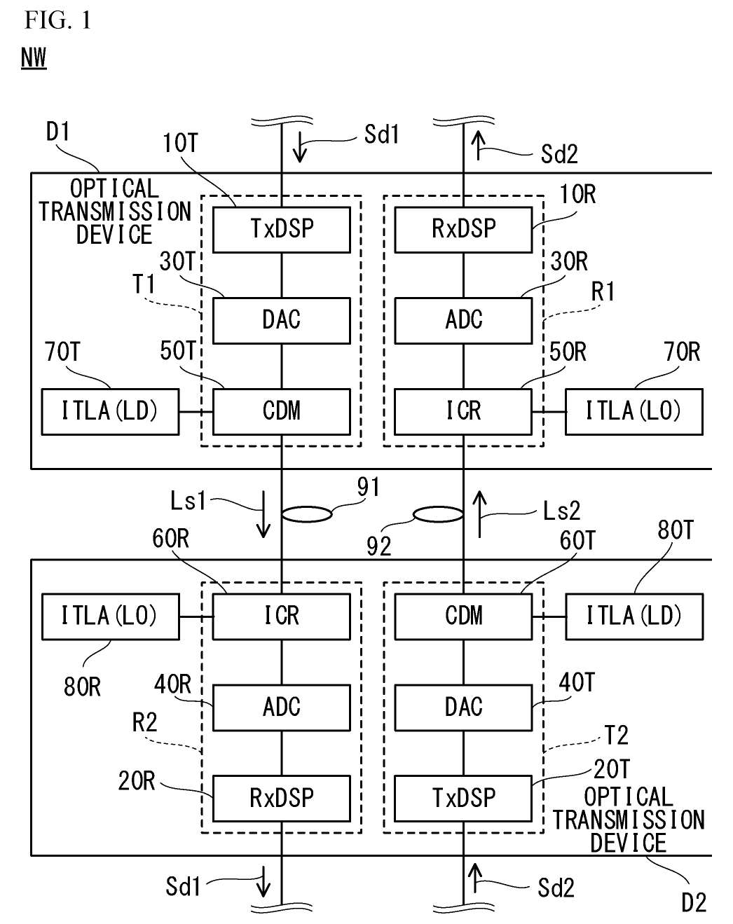

As illustrated in FIG. 1, an optical network NW includes two optical transmission devices D1 and D2. The optical transmission devices D1 and D2 are connected to each other via transmission lines 91 and 92. The transmission lines 91 and 92 include optical fibers, respectively. The optical transmission device D1 receives an electrical digital signal Sd1 such as an Ethernet signal from a client network. The digital signals Sd1 include a data signal corresponding to a main signal. The digital signal may include a control signal including only a parameter for adjusting the transmission characteristics or the like.

The optical transmission device D1 converts the digital signals Sd1 into signal light Ls1 and transmits the signal light Ls1 to the transmission line 91. Thus, the signal light Ls1 propagates through the transmission line 91. The optical transmission device D2 receives the signal light Ls1 from the transmission line 91. When the optical transmission device D2 receives the signal light Ls1, the optical transmission device D2 converts the signal light Ls1 into a digital signal Sd1 and transmits the digital signal Sd1 to the client network.

The optical transmission device D2 is basically the same as the optical transmission device D1, and thus detailed description thereof will be omitted. For example, when the optical transmission device D2 receives the digital signal Sd2 from the client network, the optical transmission device D2 converts the digital signal Sd2 into signal light Ls2 and transmits the signal light Ls2 to the transmission line 92. Thus, the signal light Ls2 propagates through the transmission line 92. The optical transmission device D1 receives the signal light Ls2 from the transmission line 92. When the optical transmission device D1 receives the signal light Ls2, the optical transmission device Ls2 converts the signal light Sd2 into a digital signal Sd2 and transmits the digital signal sd2 to the client network.

Here, the optical transmission device D1 includes an optical transmitter T1 and an optical receiver R1. The optical transmitter T1 is an example of a first optical transmission device. The optical transmission device D2 includes an optical transmitter T2 and an optical receiver R2. The optical receiver R2 is an example of a second optical transmission device. For example, an optical transmission system is realized by the optical transmitter T1 and the optical receiver R2. The optical transmission system may be realized by the optical transmitter T2 and the optical receiver R1. The optical transmission system may be realized by the optical transmitter T1 and the optical receiver R1.

The optical transmitter T1 includes a Tx digital signal processor (TxDSP) 10T, a digital to analogue converter (DAC) 30T, and a coherent driver modulator (CDM) 50T. TxDSP 10T is a DSP mounted on the optical transmission device D1. The CDM 50T is an example of a transmission circuit, and is an integrated circuit in which a driver amplifier and an optical modulator are housed in a single package. The optical transmitter T1 may include an integratable tunable laser assembly (ITLA) 70T provided in an optical transmission device D1. The ITLA 70T includes a laser diode (LD) as a source of light that outputs transmission light (in particular, laser light).

The optical receiver R1 includes a RxDSP 10R, an analogue to digital converter (ADC) 30R, and an integrated coherent receiver (ICR) 50R. The RxDSP10R is a DSP mounted on the optical transmission device D1. The ICR 50R is an integrated circuit in which a 90° optical hybrid circuit, a balanced photo diode (BPD), and a transimpedance amplifier (TIA) are housed in one package. The optical receiver R1 may include an ITLA 70R provided in the optical transmission device D1. The ITLA 70R includes a local oscillator (LO) as a source that outputs local light (in particular, laser light).

The optical transmitter T2 has a TxDSP 20T, a DAC 40T, and a CDM 60T. The optical transmitter T2 may include an ITLA 80T provided in the optical transmission device D2. As described above, the optical transmitter T2 is basically the same as the optical transmitter T1, and thus detailed description thereof will be omitted. The optical receiver R2 includes a RxDSP 20R, an ADC 40R, and an ICR 60R. The ICR 60R is an example of a reception circuit. The optical receiver R2 may include an ITLA 80R provided in the optical transmission device D2. As described above, the optical receiver R2 is basically the same as the optical receiver R1, and thus, detailed description thereof will be omitted.

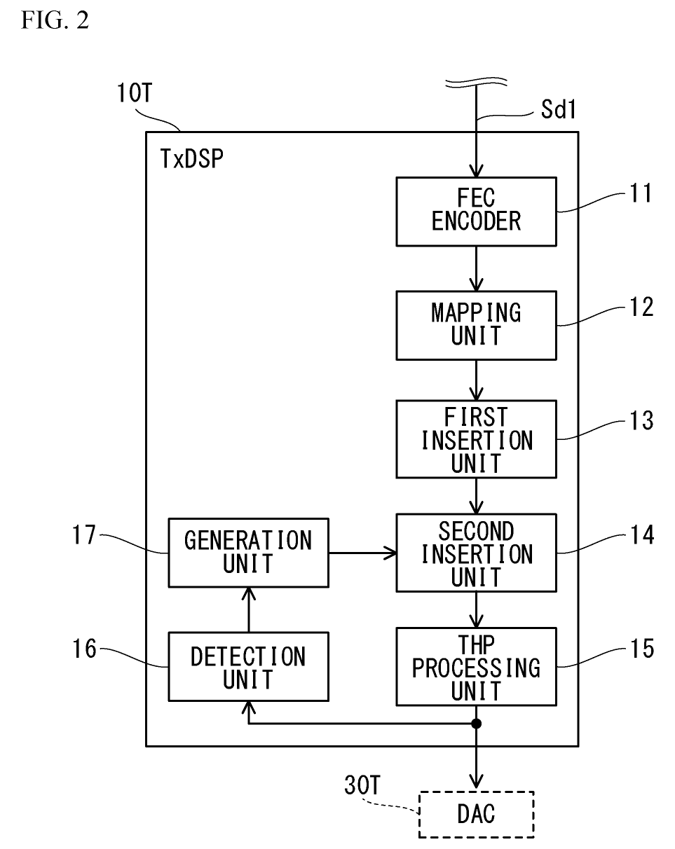

The functional configuration of the TxDSP 10T will be described with reference to FIGS. 2 to 5. Since the TxDSP 20T is basically the same as the TxDSP 10T, detailed description thereof will be omitted.

The TxDSP10T includes a forward error correction (FEC) encoder 11, a mapping unit 12, a first insertion unit 13, a second insertion unit 14, a THP processing unit 15, a detection unit 16, and a generation unit 17. The first insertion unit 13 is an example of a first signal inserter. The second insertion unit 14 is an example of a third signal inserter. Although not illustrated, the TxDSP 10T has a framer in a preceding stage of the FEC encoder 11. When the digital signal Sd1 is input, the framer accommodates the digital signal Sd1 in a transfer frame, and generates a binary data bit string as a data signal corresponding to the transfer frame. For example, the transfer frame is an optical channel transport unit (OTU) frame.

When the binary data bit string corresponding to the transfer frame is input, the FEC encoder 11 generates an FEC and inserts the FEC into the binary data bit string. The mapping unit 12 performs symbol mapping processing based on a setting value of the modulation method. The setting value of the modulation method is QPSK, 16QAM (Quadrature Amplitude Modulation), or the like. The symbol mapping processing is processing of converting the binary data bit string into a data symbol string including a plurality of data symbols. The data symbol is an example of a second signal. After performing the symbol mapping processing, the mapping unit 12 outputs the data symbol string to the first insertion unit 13.

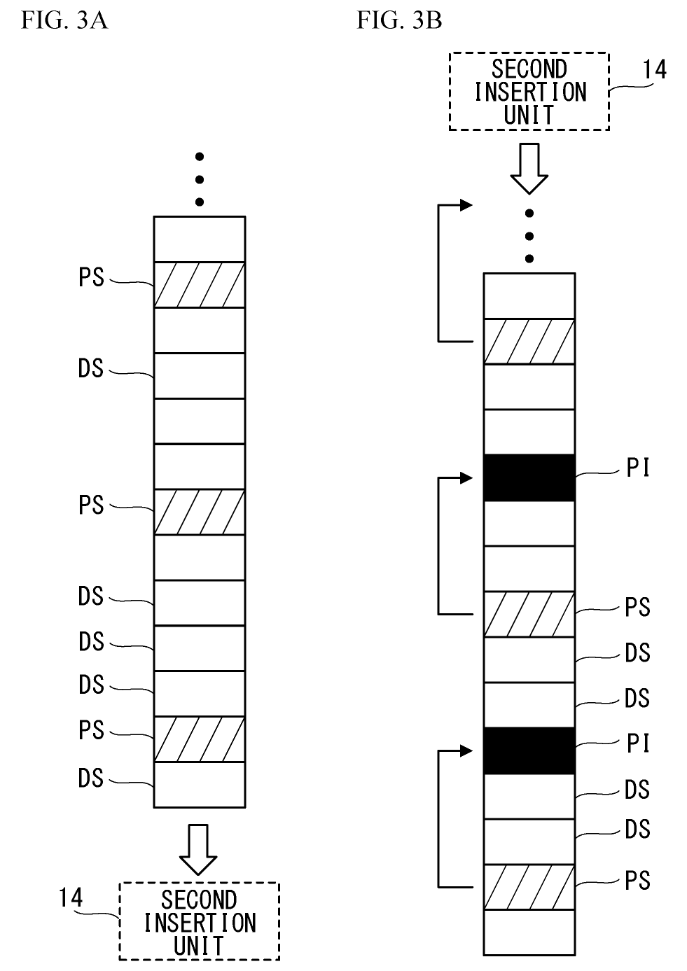

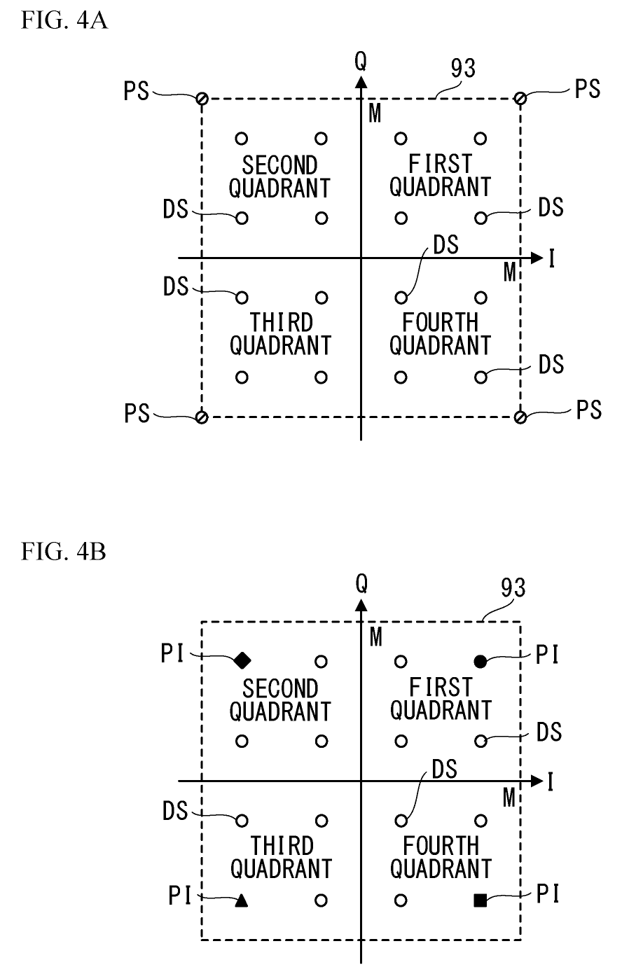

The first insertion unit 13 inserts pilot symbols as known signals whose modulation method is QPSK into the data symbol string at unit symbol intervals (for example, at intervals of several tens of symbols). The pilot symbol is an example of a first signal. As a result, as illustrated in FIG. 3A, the pilot symbols PS are inserted between the plurality of data symbols DS at unit symbol intervals. As illustrated in FIG. 4A, the pilot symbols PS whose modulation method is QPSK are mapped to four signal points corresponding to QPSK on a constellation map in which a plurality of pilot symbols PS are mapped to 16 signal points corresponding to 16QAM. As illustrated in FIG. 3A, the data symbol string in which the pilot symbol PS is inserted between the plurality of data symbols DS is input to the second insertion unit 14. The data symbol string in which the pilot symbol PS is inserted between the plurality of data symbols DS is an example of a first digital signal.

As illustrated in FIG. 4A, the four signal points to which the pilot symbols PS are mapped are located at the four vertices of a virtual square 93 whose one side is defined by twice a modulo amplitude “M”. The modulo amplitude “M” is set in a modulo operator included in the THP processing unit 15 so as not to exceed an input range of the DAC 30T. For details of the THP processing unit 15 including the modulo operator, for example, known patent documents such as Japanese Patent Application Publication No. 2013-258694 and Japanese Patent Application Publication No. 2024-58713 can be referred to.

The second insertion unit 14 inserts the phase information symbol PI generated by the generation unit 17 into the data symbol string input from the first insertion unit 13. The phase information symbol PI is an example of a third signal. As a result, as illustrated in FIG. 3B, the phase information symbol PI is further inserted into the data symbol string in which the pilot symbol PS is inserted between the plurality of data symbols DS. That is, the second insertion unit 14 generates a data symbol string in which the phase information symbol PI is further inserted into the data symbol string in which the pilot symbol PS is inserted between the plurality of data symbols DS. When the modulation method is QPSK, as illustrated in FIG. 4B, the phase information symbols PI are mapped to four signal points that are farthest from the center of the constellation map among 16 signal points corresponding to 16QAM. Therefore, the phase information symbols PI are mapped inside the virtual square 93. The data symbol string in which the pilot symbol PS and the phase information symbol PI are inserted between the plurality of data symbols DS is an example of a second digital signal.

Referring back to FIG. 2, the THP processing unit 15 performs THP processing on the data symbol string before the phase information symbol PI is inserted and the data symbol string after the phase information symbol PI is inserted. That is, before the phase information symbol PI is inserted, the THP processing unit 15 precodes each of the data symbol strings in which the pilot symbol PS is inserted between the plurality of data symbols DS, based on the THP method. After the phase information symbol PI is inserted, the THP processing unit 15 precodes each of the data symbol strings in which the pilot symbol PS and the phase information symbol PI are inserted between the plurality of data symbols DS, based on the THP method. This reduces the inter-symbol interference due to the limitation of the transmission band of the transmission line 91. The data symbol string after the THP processing is performed on the data symbol string in which the pilot symbol PS and the phase information symbol PI are inserted between the plurality of data symbols DS is an example of a third digital signal.

When the THP processing is executed, the pilot symbols PS (see FIG. 4A) located at the four vertices of the square 93 on the constellation map may move to the other four vertices of the same square 93 depending on the previous data symbol DS and the tap coefficients included in the THP processing unit 15. For example, the pilot symbol PS mapped to the signal point in the second quadrant is moved to the signal point in the fourth quadrant. In this way, the pilot symbols PS mapped on the four vertices of the square 93 maintain the amplitude and maintain the QPSK even when the THP processing is executed, and thus, complicated reception processing that increases the amount of computation is avoided. On the other hand, the phase information of the pilot symbol PS is lost due to the phase shift of the pilot symbol PS, and it becomes difficult to use the pilot symbol PS as a known signal including the phase information.

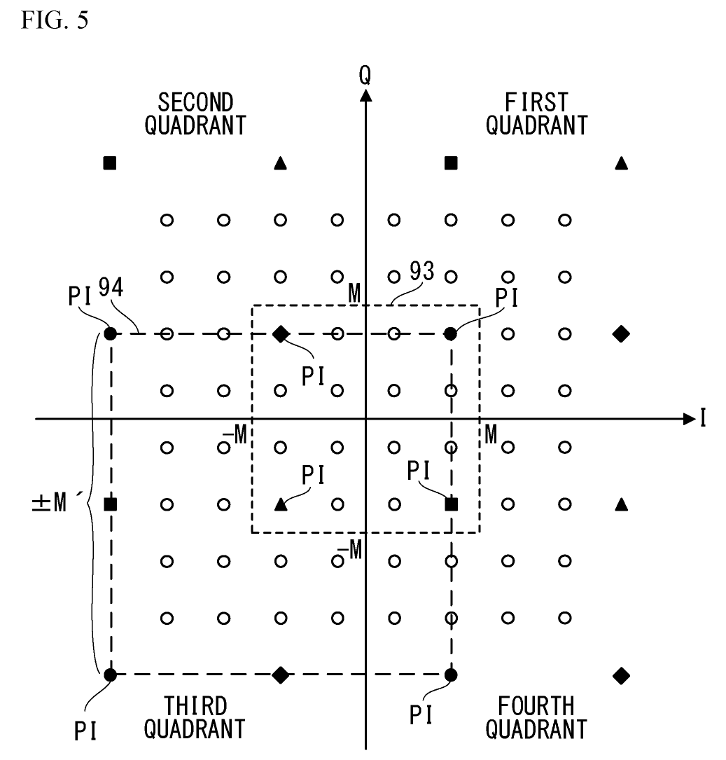

When the THP processing is executed, the phase information symbol PI (see FIG. 4B) mapped to the constellation map is expanded to any of 16 signal points located inside and outside the square 93, as illustrated in FIG. 5. For example, the phase information symbol PI (black circle) mapped to the signal point in the first quadrant may expand and move to any one of the signal points in the second quadrant, the third quadrant, and the fourth quadrant, or may remain at the signal point in the first quadrant. Thus, since the phase information symbol PI is located inside the four vertices of the square 93, it is moved onto one of the four vertices of a virtual square 94 whose one side is the modulo amplitude “2M′”.

Returning to FIG. 2, the detection unit 16 detects the phase of the pilot symbol PS after the THP processing. The detection unit 16 can detect the phase of the pilot symbol PS after the THP processing with respect to the data symbol string before the phase information symbol PI is inserted. The detection unit 16 can also detect the phase of the pilot symbol PS after the THP processing on the data symbol string after the phase information symbol PI is inserted. The generation unit 17 generates the phase information symbol PI based on the phase of the pilot symbol PS detected by the detection unit 16, and outputs the phase information symbol PI to the second insertion unit 14. For example, when the pilot symbol PS mapped to the signal point in the second quadrant is moved to the signal point in the fourth quadrant (see FIG. 4A), the generation unit 17 generates and outputs the phase information symbol PI including the quadrant information of the pilot symbol PS moved by the THP processing as the phase information. Accordingly, the second insertion unit 14 can insert the phase information symbol PI after the pilot symbol PS with respect to the data symbol string in which the pilot symbol PS is inserted between the plurality of data symbols DS (see FIG. 3B).

The data symbol string, into which the phase information symbol PI is inserted and which is subjected to the THP processing, is output to the DAC 30T as a transmission signal (see FIG. 2). The DAC 30T converts the transmission signal from a digital format to an analog format and outputs the converted signal to the CDM 50T (see FIG. 1). The CDM 50T amplifies the signal amplitude of the transmission signal output from the DAC 30T. After amplifying the signal amplitude of the transmission signal, the CDM 50T modulates the transmission light input from the ITLA 70T based on the signal amplitude after amplification, and generates the signal light Ls1 having any optical waveform. In this way, the CDM 50T converts the electric transmission signal into the signal light Ls1 and outputs the signal light Ls1 to the transmission line 91. That is, the CDM 50T transmits the signal light Ls1 to the transmission line 91.

The signal light Ls1 propagated through the transmission line 91 is input to the ICR 60R of the optical transmission device D2. The ICR 60R receives the signal light Ls1 by the local light output from the ITLA 80R. When the ICR 60R receives the signal light Ls1, the ICR 60R converts the signal light Ls1 into a current signal. When the ICR 60R converts the signal light Ls1 into the current signal, the ICR 60R converts the current signal into a voltage signal and amplifies an amplitude of the voltage signal to an amplitude suitable for the ADC 40R. The ICR 60R outputs the amplified voltage signal to the ADC 40R as a reception data string. The ADC 40R converts the reception data string from an analog format to a digital format and outputs the converted data string to the RxDSP 20R.

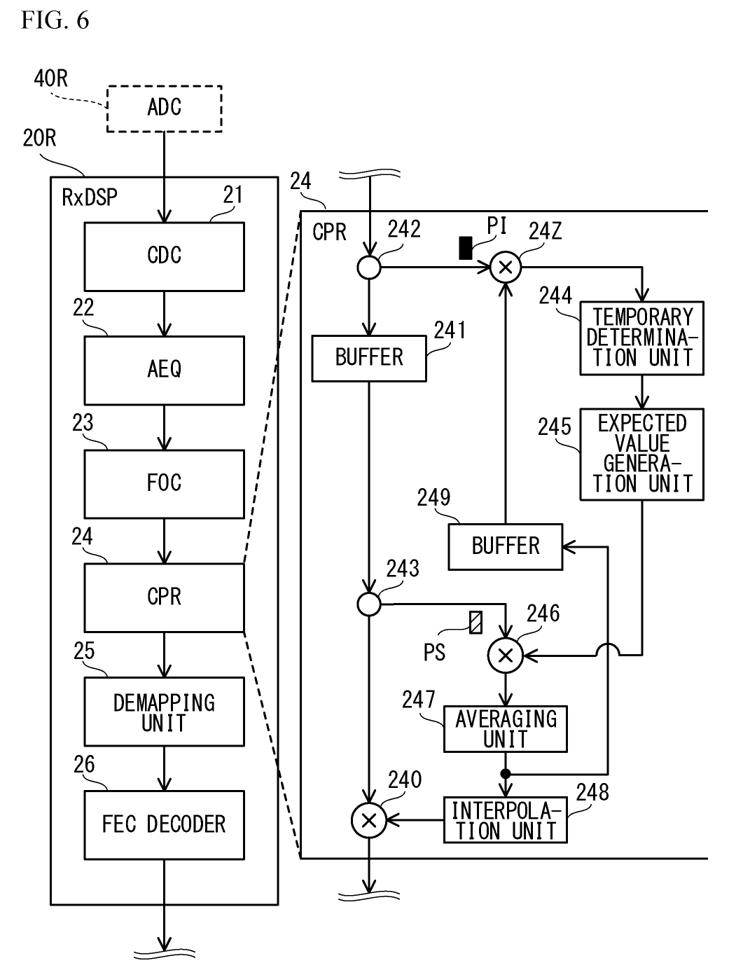

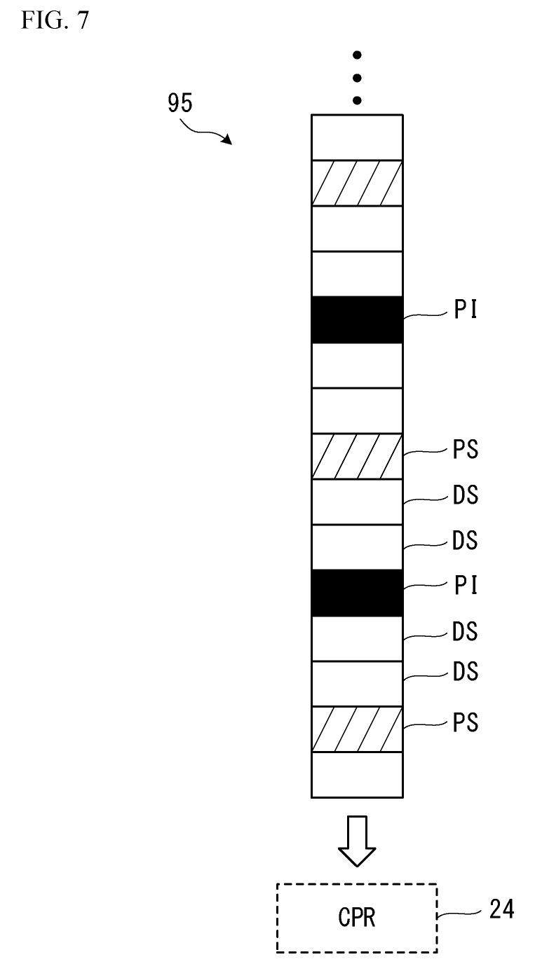

The functional configuration of the RxDSP 20R will be described with reference to FIGS. 6 and 7. Since the RxDSP 10R is basically the same as the RxDSP 20R, detailed description thereof will be omitted.

The RxDSP 20R includes a chromatic dispersion compensation (CDC) 21, an adaptive equalizer (AEQ) 22, a frequency offset compensation (FOC) 23, a carrier phase recovery (CPR) 24, a demapping unit 25, and an FEC decoder 26. The AEQ22 is an example of an adaptive equalizer. The CPR24 is an example of a compensator. The demapping unit 25 is an example of a demodulator. Although not illustrated, the RxDSP 20R has a deframer at a subsequent stage of the FEC decoder 26. The deframer will be described in detail later.

The CDC 21 fixedly compensates for waveform distortion generated in the optical transmission devices D1 and D2 and the transmission line 91 with respect to the reception data string output from the ADC 40R. Specifically, the CDC 21 mainly compensates for chromatic dispersion of the transmission line 91. In addition, waveform distortion caused by the ICR 60R, skew compensation, band characteristic compensation, and the like are also performed. The AEQ 22 adaptively compensates for the waveform distortion of the signal light Ls1 caused by the polarization mode dispersion and the polarization dependent loss generated on the transmission line 91, with respect to the reception data string output from the CDC 21. At the same time, the AEQ 22 adjusts the sampling timing of the reception data string output from the ADC 40R, and outputs the data string in units of symbol to the FOC 23 as a reception symbol string. The AEQ 22 may adaptively equalize the data symbol DS according to only the amplitude modulation information of the pilot symbol PS, or the CPR 24 may estimate a phase error of the carrier phase of the pilot symbol PS based on the pilot symbol PS and the phase information symbol PI, update the tap coefficient based on the phase error, and adaptively equalize the data symbol DS.

The FOC 23 estimates an optical frequency offset amount indicating an amount of optical frequency offset with respect to the reception symbol string output from the AEQ 22, and compensates for the reception symbol string with the estimated optical frequency offset amount. The optical frequency offset is a differential between the frequency of the transmission light output from the ITLA 70T of the optical transmission device D1 and the frequency of the local light output from the ITLA 80R of the optical transmission device D2. The CPR 24 compensates for fluctuation components of a phase shift caused by phase noise generated in the ITLA 80R or the like, with respect to the reception symbol string after the optical frequency offset is compensated.

When the reception symbol string after the fluctuation component is compensated is input, the demapping unit 25 performs symbol demapping processing on the reception symbol based on the setting value of the modulation method. The symbol demapping process is processing of converting the data symbol DS included in the reception symbol string into the binary data bit string. After performing the symbol demapping processing, the demapping unit 25 outputs a binary data bit string to the FEC decoder 26.

The FEC decoder 26 extracts an FEC from the binary data bit string and performs data error correction. When the FEC decoder 26 performs the error correction, the deframer generates a transfer frame corresponding to the binary data bit string and extracts the digital signals Sd1 from the transfer frame. Once the deframer extracts the digital signals Sd1, the deframer transmits the extracted digital signals Sd1 to the client network.

The functional configuration of the CPR 24 will be described.

The CPR 24 includes a buffer 241, a PI extraction unit 242, a PS extraction unit 243, a temporary determination unit 244, an expected value generation unit 245, a multiplication unit 246, an averaging unit 247, an interpolation unit 248, a buffer 249, and a multiplication unit 240 and 24Z. As illustrated in FIG. 7, a reception symbol string 95 including the pilot symbol PS and the phase information symbol PI is input to the CPR 24 in units of symbol.

The buffer 241 waits for the output of the reception symbol string 95 to the subsequent stage until the phase information symbol PI is input. As illustrated in FIG. 6, the PI extraction unit 242 extracts the phase information symbol PI from the reception symbol string 95. As a result, the buffer 241 outputs the reception symbol string 95 excluding the phase information symbol PI to the subsequent stage. As illustrated in FIG. 6, the PS extraction unit 243 extracts the pilot symbol PS from the reception symbol string 95. As a result, the PS extraction unit 243 outputs the reception symbol string 95 excluding the pilot symbol PS to the subsequent stage.

The temporary determination unit 244 performs temporary determination processing on the phase information symbol PI. The temporary determination processing is processing of detecting to which phase (that is, quadrant) the pilot symbol PS after the THP processing has changed, using the phase information symbol PI. As described above, four phase information symbols PI before the THP processing move to any of 16 signal points after the THP processing (see FIG. 5). The phase information symbol PI includes quadrant information of the pilot symbol PS moved by the THP processing as the phase information. Therefore, the temporary determination unit 244 can detect the quadrant information of the pilot symbol PS by performing the temporary determination processing on 16 phase information symbols PI.

The expected value generation unit 245 generates an expected value of the phase of the pilot symbol PS based on the quadrant information of the pilot symbol PS detected by the temporary determination unit 244, and outputs the expected value to the multiplication unit 246. The multiplication unit 246 multiplies the pilot symbol PS extracted by the PS extraction unit 243 by a complex conjugate component of the expected value of the phase of the pilot symbol PS, and calculates a difference between the pilot symbol PS and the expected value. Thus, the multiplication unit 246 estimates the fluctuation components of the phase shift caused by the phase noise generated in the ITLA 80R or the like.

The averaging unit 247 calculates an average value of the fluctuation component of the phase shift output from the multiplication unit 246, and outputs the average value to each of the interpolation unit 248 and the buffer 249. The interpolation unit 248 performs interpolation processing on the average value of the fluctuation component of the phase shift by, for example, linear interpolation, generates a phase error component of a symbol other than the pilot symbol PS, and outputs the phase error component to the multiplication unit 240.

The multiplication unit 240 multiplies the data symbol DS remained after the pilot symbol PS is removed from the reception symbol string 95 by a complex conjugate component of the phase error component output from the interpolation unit 248, thereby removing the phase error component from the data symbol DS. Accordingly, the phase shift caused by the phase noise of the carrier phase with respect to the data symbol DS is compensated. The buffer 249 waits for the output of the average value of the fluctuation components of the phase shift to the multiplication unit 24Z until the phase information symbol PI at the next timing is input to the CPR 24.

When the phase information symbol PI at the next timing is input to the CPR 24, the multiplication unit 24Z multiplies the phase information symbol PI by the complex conjugate component of the average value of the fluctuation components of the phase shift, thereby removing the fluctuation components of the phase shift from the phase information symbol PI. Accordingly, the phase shift caused by the phase noise of the carrier phase with respect to the phase information symbol PI is compensated, and the processing accuracy of the temporary determination processing in the temporary determination unit 244 is improved.

As described above, according to the first embodiment, the V & V method is not used, and thus the unwrap processing performed in the V & V method is avoided. This avoids the occurrence of the phase slip which may induce a burst error. According to the first embodiment, even in the case of the data symbol DS on which the THP processing is executed, the carrier phase of the data symbol DS can be stably restored, and the deterioration of the transmission quality in the optical transmission is suppressed.

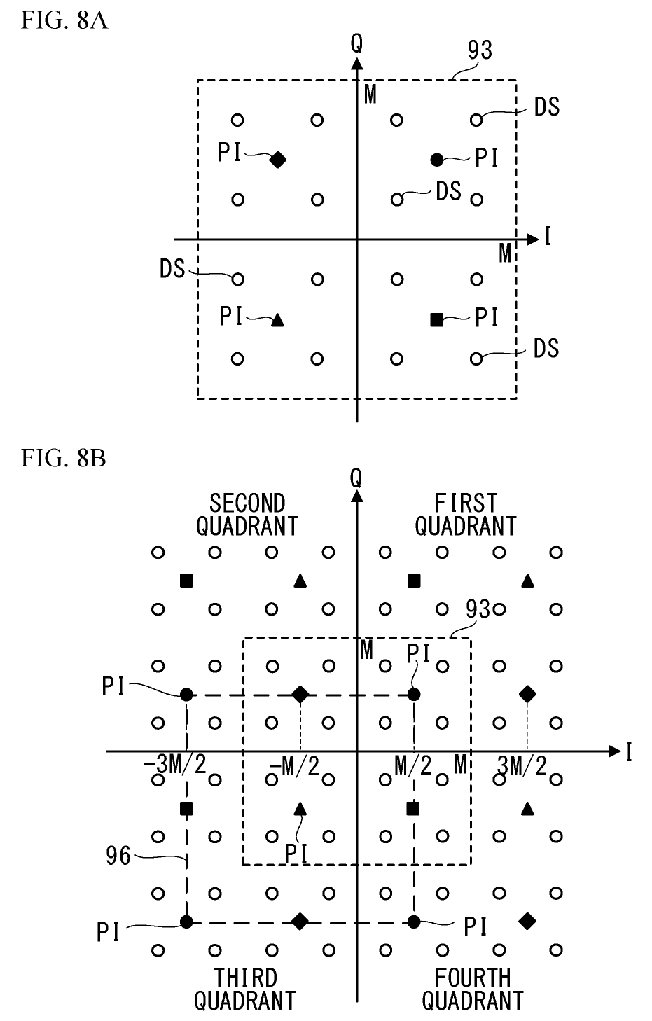

In the first embodiment, the phase information symbols PI are mapped to four signal points farthest from the center of the constellation map in the 16 signal points. However, the phase information symbol PI is not limited to such a mapping form. For example, as illustrated in FIG. 8A, the phase information symbols PI may be mapped to signal points having the same Euclidean distance from four data symbols DS mapped to the first quadrant to the fourth quadrant.

In this case, when the THP processing is executed, as illustrated in FIG. 8B, the phase information symbols PI are expanded to any of 16 signal points located inside and outside the square 93. For example, the phase information symbol PI (black circle) mapped to the signal point in the first quadrant may expand and move to any one of the signal points in the second quadrant, the third quadrant, and the fourth quadrant, or may remain at the signal point in the first quadrant. Thus, since the phase information symbol PI is located inside the four vertices of the square 93, it is moved onto one of the four vertices of another virtual square 96 whose one side is the modulo amplitude “2M”.

In the mapping form described with reference to FIGS. 8A and 8B, a peak to average power ratio (PAPR) is improved as compared with the mapping form described with reference to FIGS. 4B and 5. On the other hand, in the mapping form described with reference to FIGS. 4B and 5, the Euclidean distance is secured and the identifiability of the phase information symbol PI is improved as compared with the mapping form described with reference to FIGS. 8A and 8B.

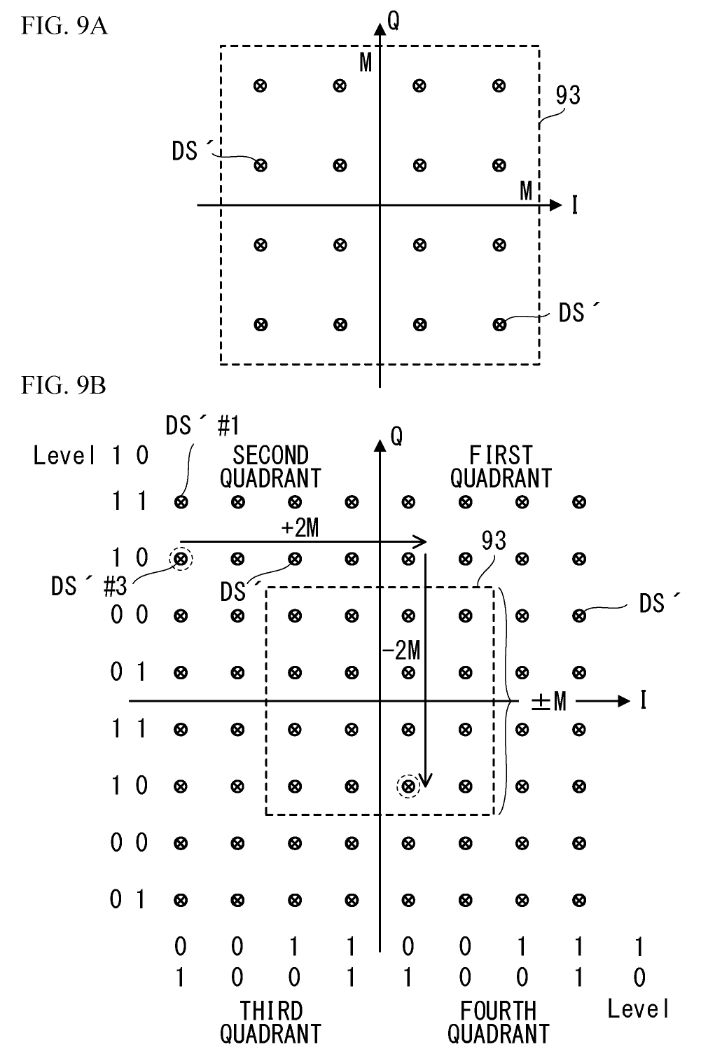

Further, in FIG. 4B and FIG. 8A, the phase information symbols PI are mapped independently from the data symbols DS, but as illustrated in FIG. 9A, data symbols DS′ including the phase information symbols PI may be mapped. For example, the data symbols DS′ may be mapped to 16 signal points corresponding to the 16QAM.

In this case, when the THP processing is executed, as illustrated in FIG. 9B, each of the symbols DS′ expands to any one of 64 signal points corresponding to 64QAM. Four-bit bit mapping that concatenates an I (In Phase) component and a Q (Quadrature Phase) component is allocated to 64 data symbols DS′. For example, bit mapping “0111” is allocated to a specific symbol DS´#1 that is farthest from the center of the constellation map among the 16 symbols DS′ mapped to the second quadrant. In this case, for example, the leading two bits “01” represent the phase information symbol PI, and the trailing two bits “11” represent the data symbol DS.

The same bit mapping before and after the movement of the data symbols DS′ is allocated to the 64 data symbols DS′. In FIG. 9B, the data symbol DS′ mapped outside the virtual square 93 is subjected to modulo processing and moved to a signal point within the square 93. For example, the data symbol DS´#3 is moved to a signal point within the square 93 by performing the modulo processing of the modulo amplitudes “+2M” and “-2M”. In such a mapping form described with reference to FIGS. 9A and 9B, since the spectrum efficiency is higher than the spectrum efficiency in the mapping form described with reference to FIGS. 4B, 8A, and the like, the number of data symbols DS that can be transmitted increases.

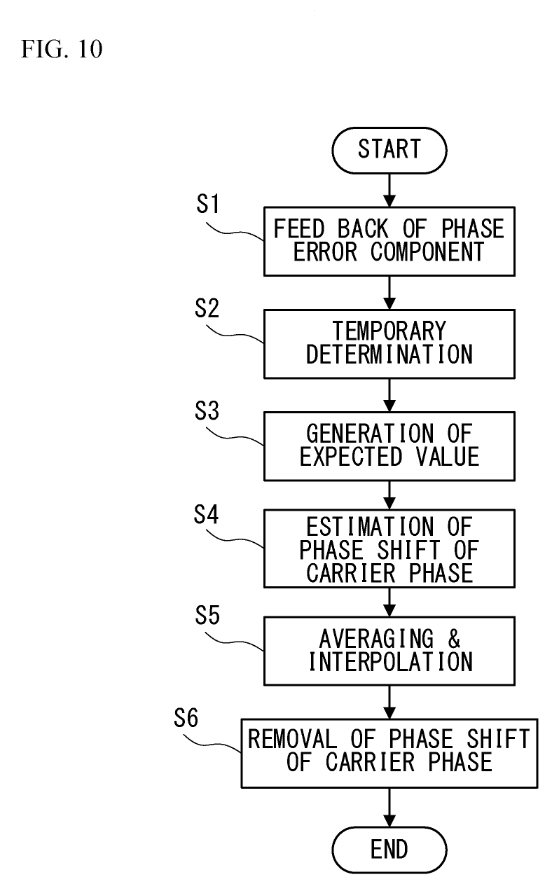

The operation of the CPR 24 according to the first embodiment will be described with reference to FIG. 10. First, the buffer 249 feeds back the phase error component to the phase information symbol PI (step S1). When the buffer 249 feeds back the phase error component, the temporary determination unit 244 performs the temporary determination on the phase information symbol PI (step S2). When the data symbol DS′ including the phase information symbol PI is input, the temporary determination unit 244 extracts the phase information symbol PI from the data symbol DS′ with reference to the bit mapping, and performs the temporary determination on the extracted phase information symbol PI.

When the temporary determination unit 244 performs the temporary determination, the expected value generation unit 245 generates the expected value of the phase of the pilot symbol PS (step S3). More specifically, the expected value generation unit 245 generates the expected value of the phase of the pilot symbol PS based on the quadrant information of the pilot symbol PS detected by the temporary determination unit 244. When the expected value generation unit 245 generates the expected value of the phase of the pilot symbol PS, the multiplication unit 246 estimates the phase shift of the carrier phase (step S4). As described above, the multiplication unit 246 estimates the fluctuation component of the phase shift by calculating the difference between the pilot symbol PS and the expected value generated by the expected value generation unit 245.

When the multiplication unit 246 estimates the phase shift of the carrier phase, the averaging unit 247 calculates the average value of the fluctuation components of the phase shift, and the interpolation unit 248 performs the interpolation processing on the average value of the fluctuation components of the phase shift (step S5). When the interpolation unit 248 performs the interpolation processing, the multiplication unit 240 removes the phase shift of the carrier phase from the data symbol DS (step S6), and the process is terminated. In this way, the CPR 24 compensates for the phase shift of the carrier phase with respect to the data symbol DS and recovers the carrier phase.

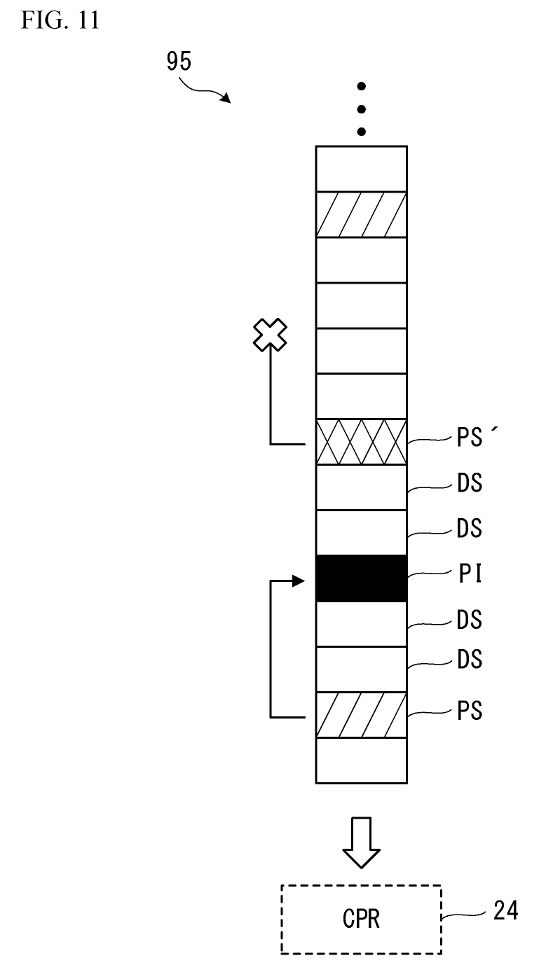

With reference to FIG. 11, a case where the pilot symbol PS into which the phase information symbol PI is inserted and the pilot symbol PS′ into which the phase information symbol PI is not inserted are mixed in the reception symbol string 95 will be described.

In this case, as for the pilot symbol PS into which the phase information symbol PI is inserted, as described above, the CPR24 may perform the temporary determination on the phase information symbol PI, generate the expected value of the phase of the pilot symbol PS, and estimate the phase shift of the carrier phase of the pilot symbol PS, as described above. On the other hand, with respect to the pilot symbol PS′ into which the phase information symbol PI is not inserted, the phase information of the pilot symbol PS′ after the THP processing is unknown. Therefore, the CPR 24 estimates the phase shift of the carrier phase of the pilot symbol PS′ based on the V & V method.

When the V & V method is used, the phase slip may occur, but if a subsequent phase information symbol PI is included in the reception symbol string 95, the CPR 24 can correct the phase slip based on the phase information symbol PI. Since the burst error that may occur due to the V & V method occurs for a short period, it is assumed that the optical transmission in the optical network NW is less affected.

### Second Embodiment

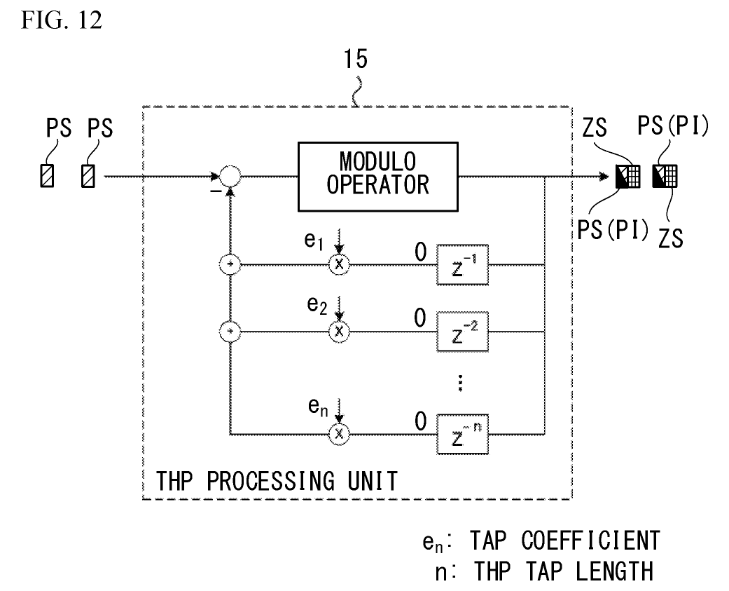

A second embodiment of the present disclosure will be described with reference to FIGS. 12 to 15. First, as illustrated in FIG. 12, the THP processing unit 15 according to the second embodiment inserts a zero symbol ZS immediately before the pilot symbol PS. The zero symbol ZS is an example of a cancellation signal that cancels out the change in the pilot symbol PS. The number of zero symbols ZS inserted by the THP processing unit 15 may be one or more. By inserting the zero symbol ZS immediately before the pilot symbol PS, the phase of the pilot symbol PS is maintained without change even when the THP processing is executed. As a result, the pilot symbol PS is used as the phase information symbol PI in the CPR 24.

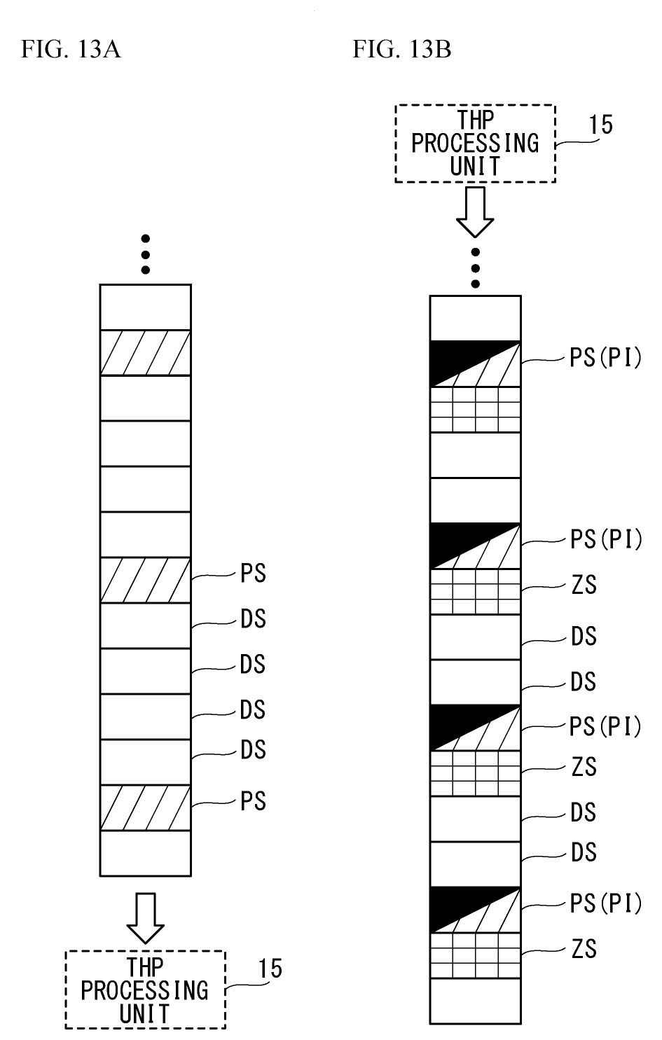

Accordingly, as illustrated in FIG. 13A, when the data symbol string in which the pilot symbol PS is inserted between the plurality of data symbols DS without including the phase information symbol PI is input to the THP processing unit 15, the zero symbol ZS is inserted into the data symbol string as illustrated in FIG. 13B. As described above, the zero symbol ZS is inserted immediately before the pilot symbol PS.

The phase of the pilot symbol PS, which is substantially shared with the phase information symbol PI, does not change in the THP processing. Therefore, the pilot symbol PS may be in the mapping form described with reference to FIG. 4B or in the mapping form described with reference to FIG. 8A, without limiting the mapping form described with reference to FIG. 4A.

By making the pilot symbol PS substantially common to the phase information symbol PI, as described in the first embodiment, the expected value of the pilot symbol PS can be input to the multiplication unit 246 as it is without generating the expected value of the pilot symbol PS. Therefore, the buffer 241, the PI extraction unit 242, the temporary determination unit 244, the expected value generation unit 245, the buffer 249, and the multiplication unit 24Z described in the first embodiment can be excluded from the CPR 24, and the CPR 24 can be realized with a simple circuit configuration.

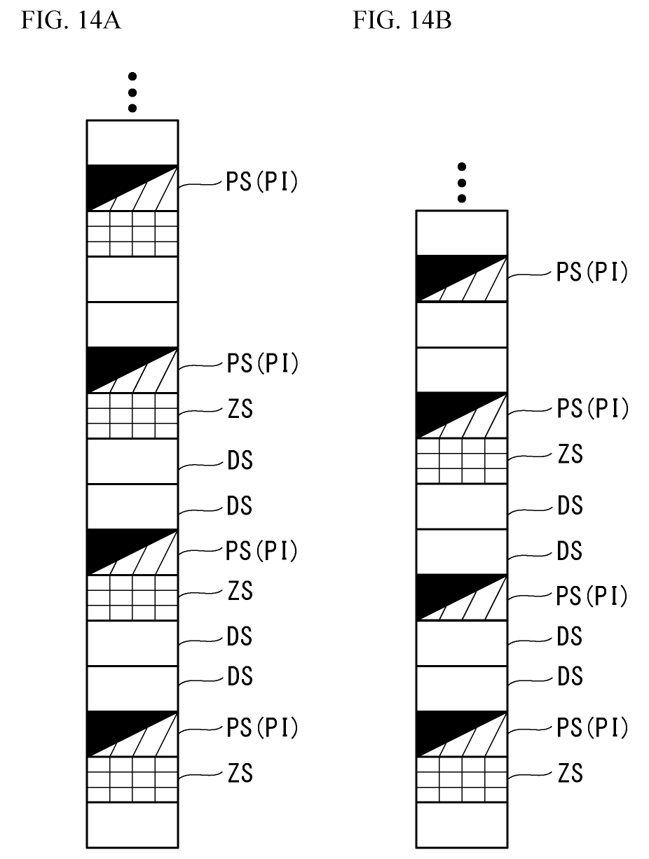

As illustrated in FIG. 14A, the zero symbol ZS may be always inserted immediately before the pilot symbol PS every one period, or may be inserted immediately before the pilot symbol PS every two periods, for example, as illustrated in FIG. 14B. In this case, the phase shift of the carrier phase of the pilot symbol PS into which the zero symbol ZS is inserted is estimated by the CPR 24 from which the temporary determination unit 244, the expected value generation unit 245, and the like are excluded. On the other hand, the phase shift of the carrier phase of the pilot symbol PS into which the zero symbol ZS is not inserted is estimated based on the V & V method.

Although the V & V method is used, as described above, the CPR 24 can correct the phase slip, and the burst error that may occur due to the V & V method also occurs for the short period, and thus it is assumed that the optical transmission in the optical network NW is less affected.

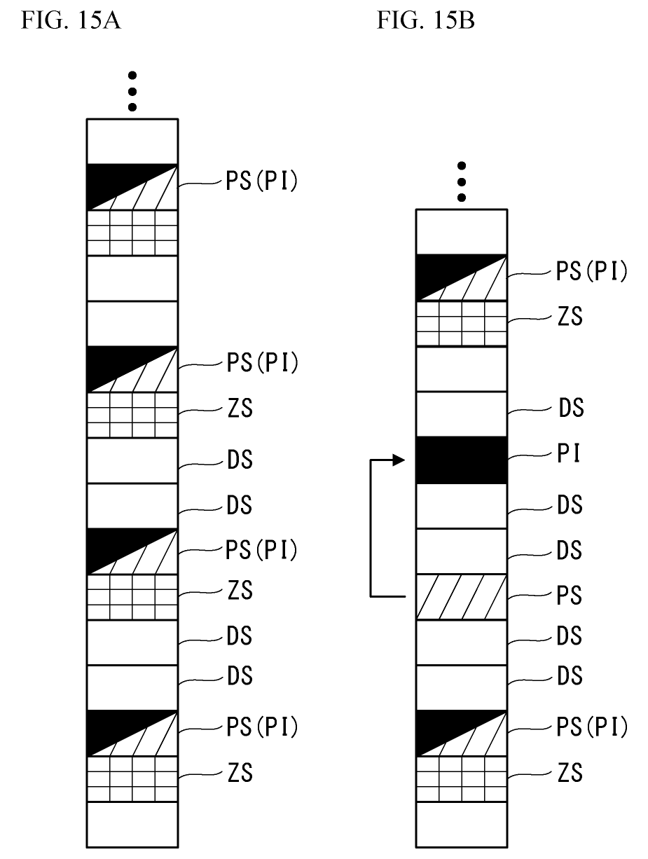

In addition, as illustrated in FIG. 15A, the zero symbol ZS may be always inserted immediately before the pilot symbol PS every one period, or as illustrated in FIG. 15B, for example, may be inserted immediately before the pilot symbol PS every three periods. In this case, the phase shift of the carrier phase of the pilot symbol PS into which the zero symbol ZS is inserted is estimated by the CPR 24 from which the temporary determination unit 244, the expected value generation unit 245, and the like are excluded. On the other hand, the phase shift of the carrier phase of the pilot symbol PS into which the zero symbol ZS is not inserted is estimated based on the phase information symbol PI, as described in the first embodiment.

### Third Embodiment

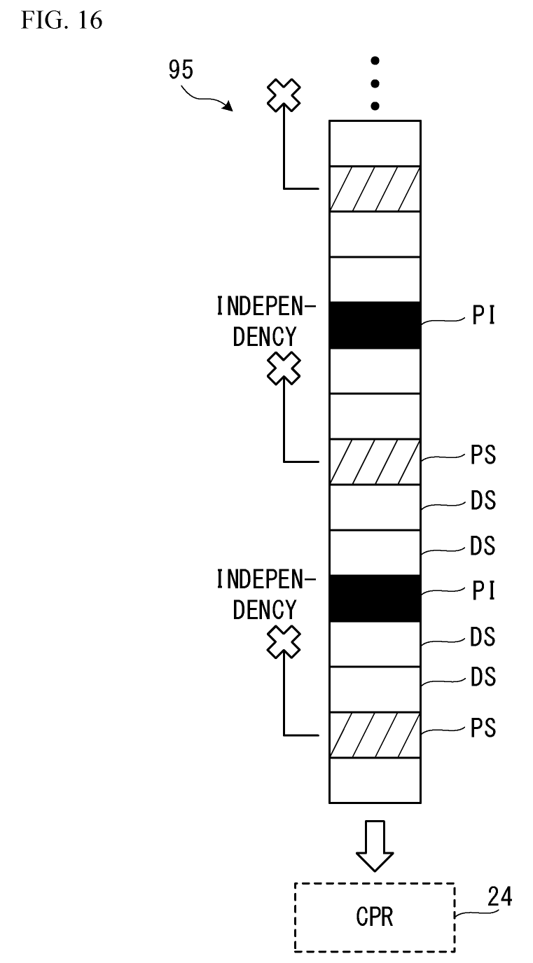

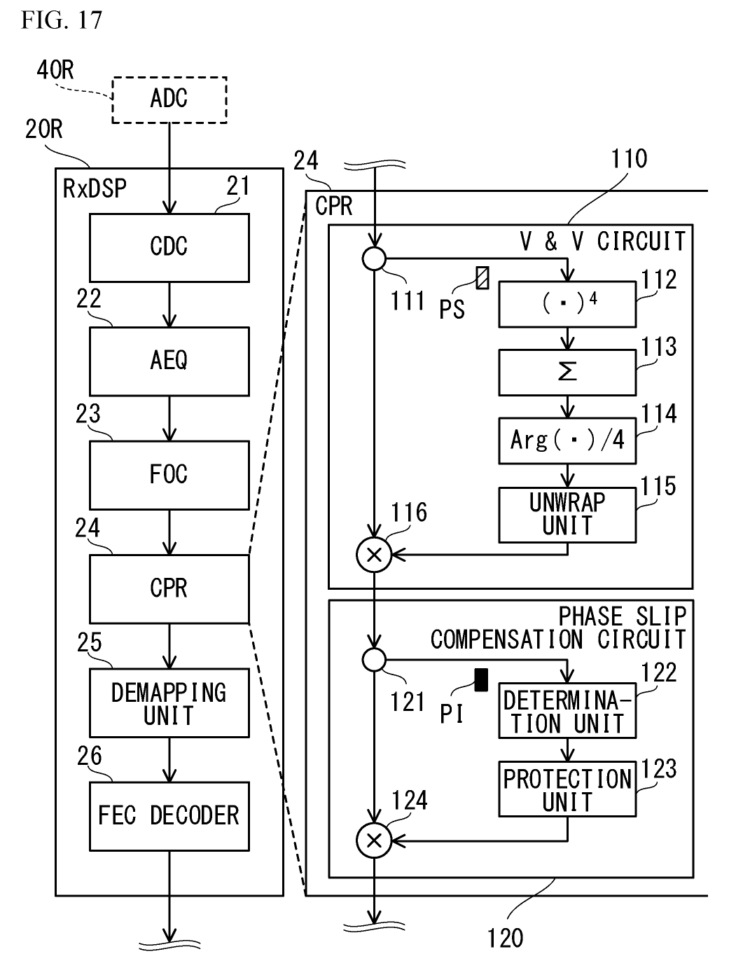

A third embodiment of the present disclosure will be described with reference to FIGS. 16 and 17. First, as illustrated in FIG. 16, the reception symbol string 95 including the phase information symbol PI independent of the pilot symbol PS as a known signal may be input to the CPR 24. In this way, when the phase information symbol PI is independent of the pilot symbol PS, the phase information of the pilot symbol PS becomes indefinite, and therefore it is difficult to completely estimate the phase shift of the carrier phase using the pilot symbol PS.

In such a case, as illustrated in FIG. 17, a V & V circuit 110 and a phase slip compensation circuit 120 may be provided in the CPR 24. The V & V circuit 110 is an example of a first compensator that compensates for the phase error of the carrier phase of the pilot symbol PS based on the V & V method. The V & V method is an example of an M-th power method, where M is the number of modulation levels (e.g. M = 2, 4, 8, 16, 64 …). The phase slip compensation circuit 120 is an example of a second compensation unit that compensates for the phase slip based on the phase information symbol PI. The V & V circuit 110 includes a PS extraction unit 111, a fourth power unit 112, an averaging unit 113, a division unit 114, an unwrap unit 115, and a multiplication unit 116. The phase slip compensation circuit 120 includes a PI extraction unit 121, a determination unit 122, a protection unit 123, and a multiplication unit 124.

The PS extraction unit 111 extracts the pilot symbol PS from the reception symbol string 95, and outputs the pilot symbol PS to the fourth power unit 112. The fourth power unit 112 raises the complex electric field of the pilot symbol PS to the fourth power. The averaging unit 113 averages a predetermined number of pilot symbols PS to reduce noise components. The division unit 114 calculates an argument 4φ which is four times that of the pilot symbol PS based on arctan (Q/I) of the I component and the Q component of the averaged pilot symbol PS, and calculates the phase error component of the carrier phase by multiplying the argument 4φ by (1/4) (i.e., division by 4).

The unwrap unit 115 performs the unwrap processing. The unwrap processing is processing of correcting a phase error component of the carrier phase so that a difference between the phase error component of the carrier phase of a previous input symbol and the phase error component of a current carrier phase reduces, and smoothly connecting the carrier phases. The multiplication unit 116 multiplies the input data symbol DS and the input phase information symbol PI by the phase error component output from the unwrap unit 115. Accordingly, the multiplication unit 116 removes the phase error component to compensate for the phase error of the carrier phase of the data symbol DS and the phase information symbol PI.

When the reception symbol string 95 output from the multiplication unit 116 is input, the PI extraction unit 121 extracts the phase information symbol PI from the input reception symbol string 95 and outputs the phase information symbol PI to the determination unit 122. The determination unit 122 determines the phases of the 16 phase information symbols PI after the phase error is compensated for, based on a specific identification threshold value for individually identifying the 16 phase information symbols PI (see FIG. 5). For example, three specific identification thresholds are prepared for each of the I direction and the Q direction.

The determination unit 122 compares the determined phase with the phase information symbol PI as a known signal, and determines whether the phase slip occurs. When the occurrence of the phase slip is detected, the protection unit 123 rotates the phase of the phase information symbol PI and outputs phase slip information including the rotated phase to the multiplication unit 124. The multiplication unit 124 multiplies the input data symbol DS by the phase slip information output from the protection unit 123 to remove the phase slip information and compensate for the phase slip of the carrier phase of the data symbol DS.

As described above, even when the reception symbol string 95 including the phase information symbol PI independent of the pilot symbol PS as a known signal is input to the CPR 24, the CPR 24 can stably restore the carrier phase of the signal on which the THP processing is executed.

### Fourth Embodiment

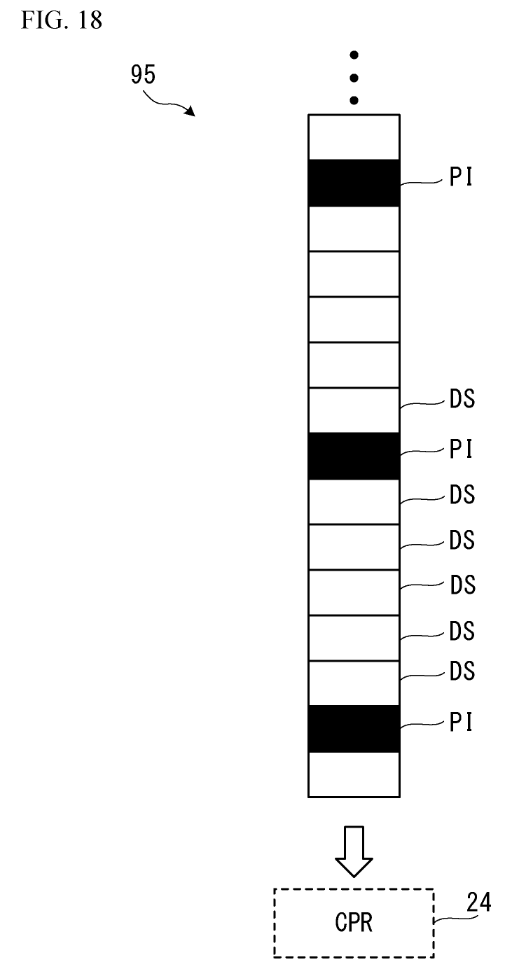

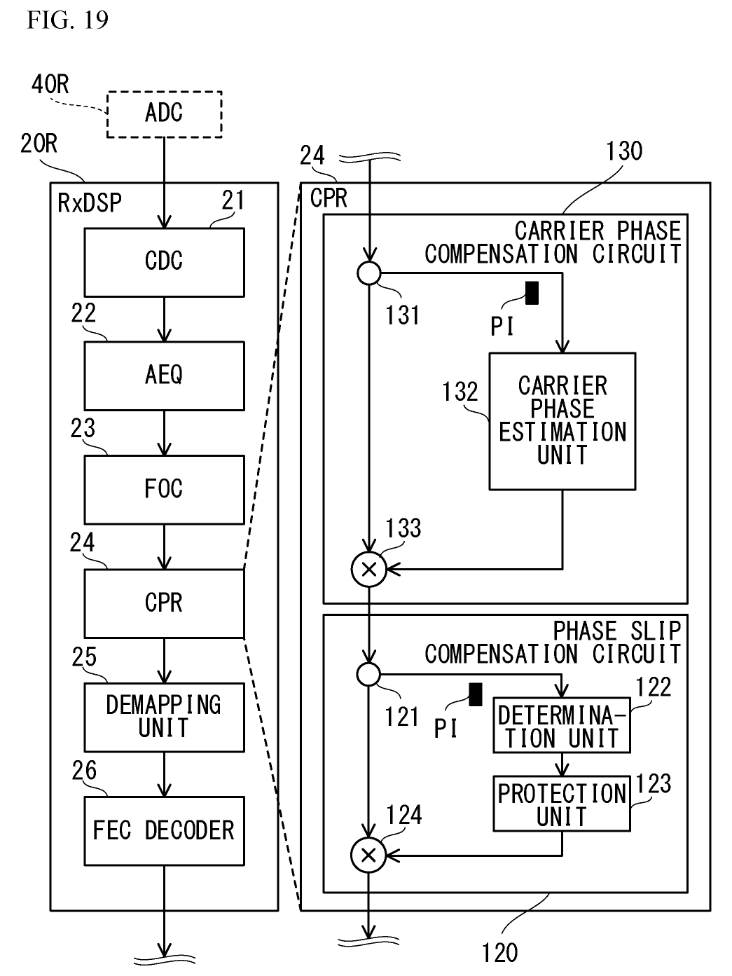

A fourth embodiment of the present disclosure will be described with reference to FIGS. 18 and 19. First, as illustrated in FIG. 18, the reception symbol string 95 including the phase information symbol PI as a known signal without including the pilot symbol PS is input to the CPR 24. As described above, when the reception symbol string 95 does not include the pilot symbol PS, it is difficult to estimate the phase shift of the carrier phase of the pilot symbol PS.

In such a case, as illustrated in FIG. 19, a carrier phase compensation circuit 130 and the phase slip compensation circuit 120 may be provided in the CPR 24. The carrier phase compensation circuit 130 includes a PI extraction unit 131, a carrier phase estimation unit 132, and a multiplication unit 133. The phase slip compensation circuit 120 has the same circuit configuration as the phase slip compensation circuit 120 described in the fourth embodiment, and thus detailed description thereof will be omitted.

When the reception symbol string 95 is input, the PI extraction unit 131 extracts the phase information symbol PI from the input reception symbol string 95 and outputs the phase information symbol PI to the carrier phase estimation unit 132. When the phase information symbol PI is input, the carrier phase estimation unit 132 estimates the phase error component of the carrier phase of the phase information symbol PI based on a known carrier phase estimation method. For example, as the known carrier phase estimation method, there are an improved version of the V & V method, a blind phase search (BPS) method, a maximum likelihood phase estimation method, and the like. The multiplication unit 133 multiplies each of the input data symbol DS and phase information symbol PI by the phase error component output from the carrier phase estimation unit 132. Accordingly, the multiplication unit 133 removes the phase error component to compensate for the phase error of the carrier phase of the data symbol DS and the phase information symbol PI.

As described above, even when the reception symbol string 95 including the phase information symbol PI as a known signal without including the pilot symbol PS is input to the CPR 24, the CPR 24 can stably restore the carrier phase of the signal on which the THP processing is performed. In particular, since the reception symbol string 95 does not include the pilot symbol PS, the symbol rate is reduced as compared with the first embodiment. Alternatively, the reception symbol string 95 can include many information symbols for signal processing, and the phase noise tolerance is improved.

### Fifth Embodiment

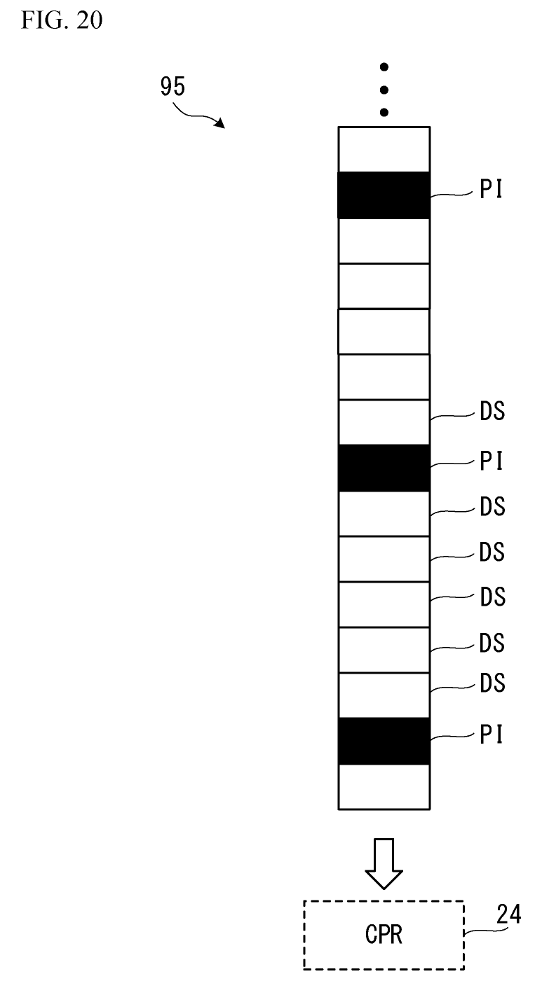

A fifth embodiment of the present disclosure will be described with reference to FIGS. 20 to 26. First, as illustrated in FIG. 20, the reception symbol string 95 including phase information symbol PI as a known signal without including pilot symbol PS may be input to the CPR 24. As in the fourth embodiment, when the reception symbol string 95 does not include the pilot symbol PS, it is difficult to estimate the phase shift of the carrier phase of the pilot symbol PS.

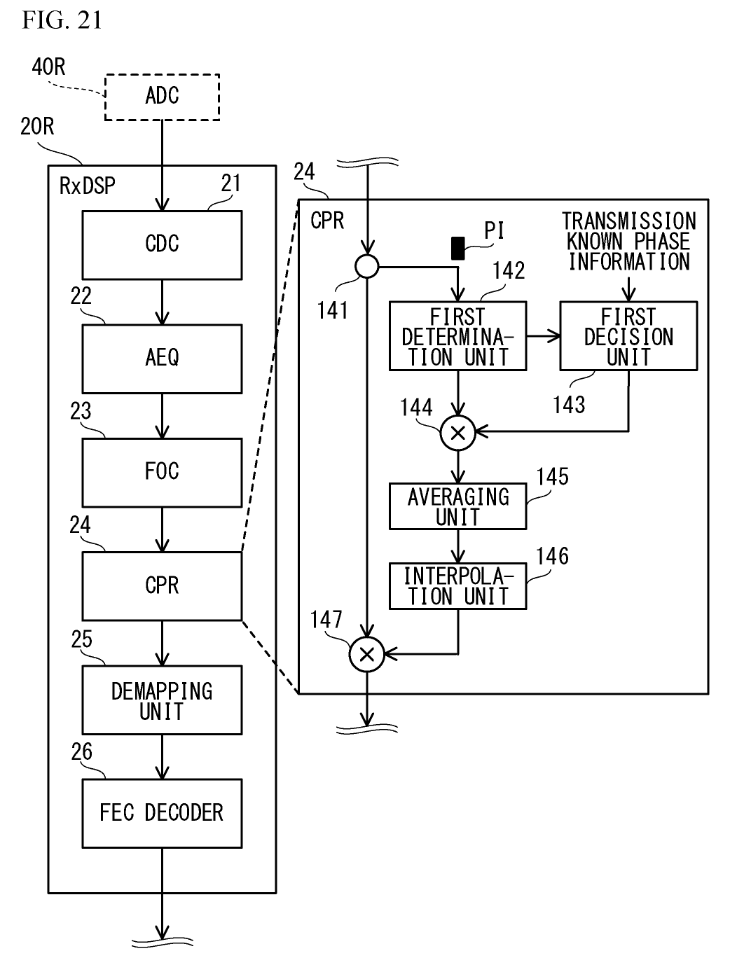

In such a case, as illustrated in FIG. 21, a PI extraction unit 141, a first determination unit 142, a first decision unit 143, a multiplication unit 144, an averaging unit 145, an interpolation unit 146, and a multiplication unit 147 may be provided in the CPR 24. When the reception symbol string 95 is input, the PI extraction unit 141 extracts the phase information symbol PI from the input reception symbol string 95 and outputs the phase information symbol PI to the first determination unit 142. The first determination unit 142 determines the type of zone to which the phase information symbol PI is mapped.

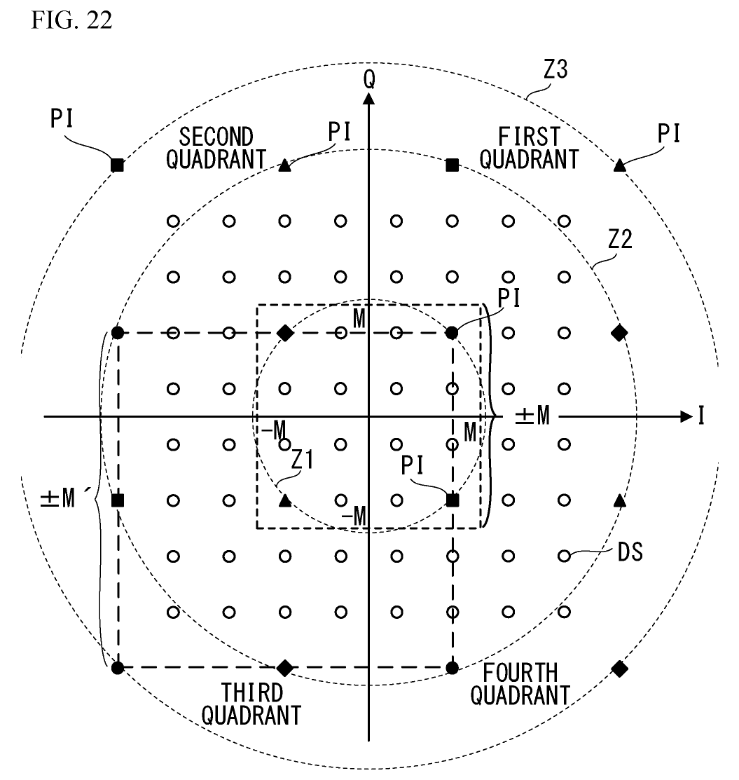

As illustrated in FIG. 22, 16 phase information symbols PI are mapped on the constellation map by the THP processing. The 4 phase information symbols PI mapped inside the virtual square 93 are the four phase information symbols PI on the inner side and a circular first zone Z1 having a radius equal to the amplitude. Four phase information symbols PI farthest from the Z3 of the constellation map are set as a third zone Z3. Remaining 8 phase information symbols PI except for the four phase information symbols PI overlapping the first zone Z1 and the four phase information symbols PI overlapping the third zone Z3 are set as a second zone Z2 having a radius larger than the radius of the first zone Z1 and smaller than the radius of the third zone Z3.

The first determination unit 142 determines whether the type of the zone to which the phase information symbol PI is mapped is the first zone Z1 or the third zone Z3, and outputs either a first determination result or a second determination result to the first decision unit 143. The first determination result indicates that the phase information symbol PI is in the first zone Z1 or the third zone Z3. The second determination result indicates that the phase information symbol PI is not in the first zone Z1 or the third zone Z3.

The first decision unit 143 decides an expected value to be output to the multiplication unit 144. For example, when the first determination result is input from the first determination unit 142, the first decision unit 143 decides the phase information included in the phase information symbol PI (hereinafter referred to as transmission known phase information) as the expected value. On the other hand, when the second determination result is input from the first determination unit 142, the first decision unit 143 decides a phase information expected value as zero.

The multiplication unit 144 multiplies the phase information symbol PI output from the first determination unit 142 by the complex conjugate component of the expected value decided by the first decision unit 143, and calculates the difference between the phase information symbol PI and the expected value. Thus, the multiplication unit 144 estimates the fluctuation components of the phase shift caused by the phase noise generated in the ITLA 80R or the like.

The averaging unit 145 calculates an average value of the fluctuation components of the phase shift output from the multiplication unit 144, and outputs the average value to the interpolation unit 146. The interpolation unit 146 performs the interpolation processing on the average value of the fluctuation components of the phase shift, and outputs the result to the multiplication unit 147 as a phase error component. The multiplication unit 147 multiplies the data symbol DS remained after the phase information symbol PI is removed from the reception symbol string 95 by the complex conjugate component of the phase error component output from the interpolation unit 146, and removes the phase error component from the data symbol DS. Accordingly, the phase shift caused by the phase noise of the carrier phase with respect to the data symbol DS is compensated.

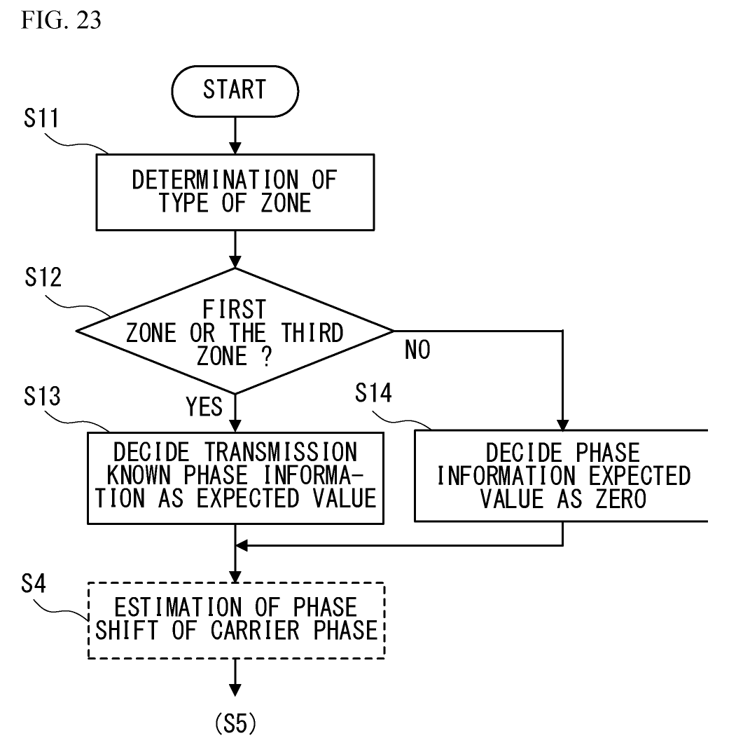

The operation of the CPR 24 according to the fifth embodiment will be described with reference to FIG. 23. The same processing in the fifth embodiment as that in the first embodiment is denoted by the same reference numerals, and detailed description thereof will be omitted.

First, the first determination unit 142 determines whether the type of the zone to which the phase information symbol PI is mapped is the first zone Z1 or the third zone Z3 (steps S11 and S12). When the type of the zone to which the phase information symbol PI is mapped is the first zone Z1 or the third zone Z3 (step S12: YES), the first decision unit 143 decides the transmission known phase information as the expected value (step S13). When the type of the zone to which the phase information symbol PI is mapped is not the first zone Z1 or the third zone Z3 (step S12: NO), the first decision unit 143 decides the as zero (step S14).

When the first decision unit 143 decides the expected value, the multiplication unit 144 executes the processing of the step S4, and the averaging unit 145, the interpolation unit 146, and the multiplication unit 147 execute the processing of step S5 and subsequent steps. Accordingly, even when the reception symbol string 95 including the phase information symbol PI as a known signal without including the pilot symbol PS is input to the CPR 24, the CPR 24 can stably restore the carrier phase of the signal on which the THP processing is executed. In particular, since the reception symbol string 95 does not include the pilot symbol PS, the symbol rate is reduced as compared with the first embodiment. Alternatively, the reception symbol string 95 can include many information symbols for signal processing, and the phase noise tolerance is improved.

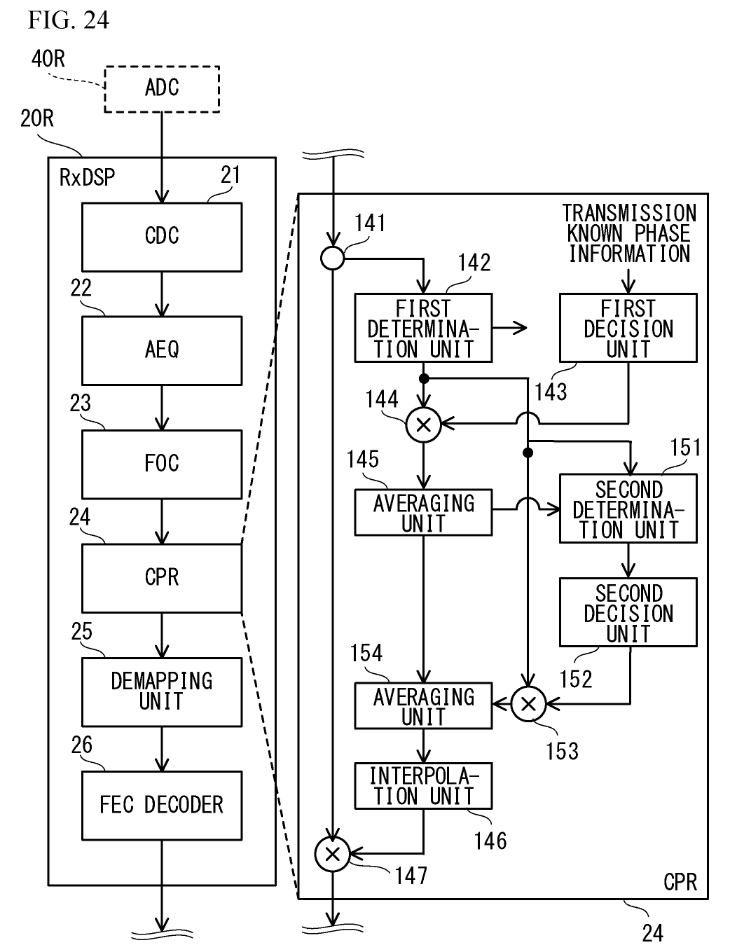

Although an example in which the CPR 24 uses the first zone Z1 and the third zone Z3 has been described, the CPR 24 may recover the carrier phase using the first zone Z1, the second zone Z2, and the third zone Z3. In this case, as illustrated in FIG. 24, a second determination unit 151, a second decision unit 152, a multiplication unit 153, and an averaging unit 154 may be further provided in the CPR 24.

The second determination unit 151 determines whether the type of the zone to which the phase information symbol PI is mapped is the second zone Z2, and outputs either a third determination result or a fourth determination result to the second decision unit 152. The third determination result indicates that the phase information symbol PI is in the second zone Z2. The fourth determination result indicates that the phase information symbol PI is not in the second zone Z2.

The second decision unit 152 decides the expected value to be output to the multiplication unit 153. For example, when the third determination result is input from the second determination unit 151, the second decision unit 152 decides the transmission known phase information as the expected value. On the other hand, when the fourth determination result is input from the second determination unit 151, the second decision unit 152 outputs the error information.

The multiplication unit 153 multiplies the phase information symbol PI output from the second determination unit 151 by the complex conjugate component of the expected value decided by the second decision unit 152, and calculates the difference between the phase information symbol PI and the expected value. Thus, the multiplication unit 153 estimates the fluctuation components of the phase shift caused by the phase noise generated in the ITLA 80R or the like. When the multiplication unit 153 estimates the fluctuation components of the phase shift, the multiplication unit 153 outputs the fluctuation components of the phase shift to the averaging unit 154. The averaging unit 154 calculates the average value of the fluctuation components of the phase shift output from the multiplication unit 153, and outputs the average value to the interpolation unit 146.

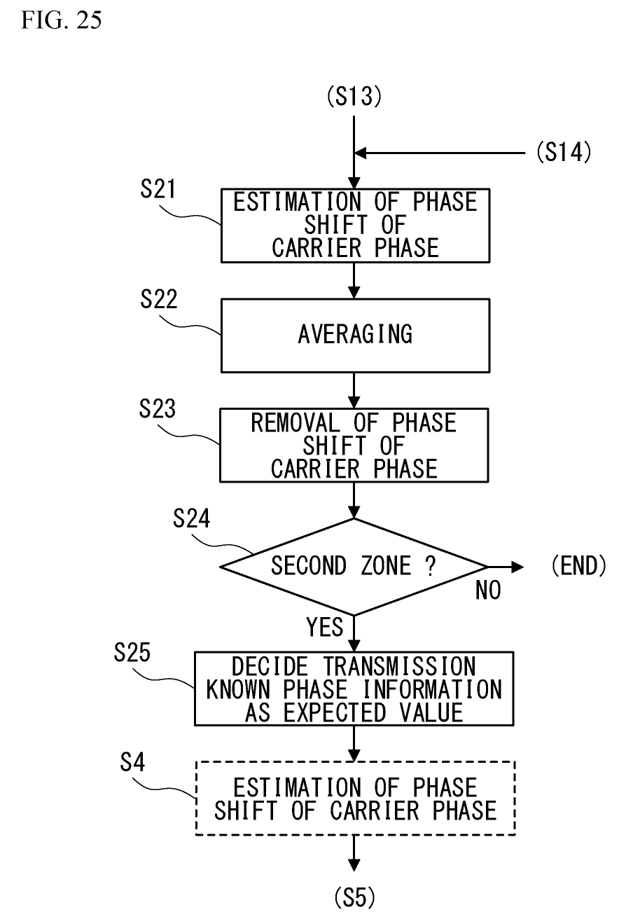

Referring to FIG. 25, an operation in a case where the CPR 24 uses the first zone Z1, the second zone Z2, and the third zone Z3 will be described.

When the processing of the steps S13 and S14 described above is completed, the multiplication unit 144 estimates the phase shift of the carrier phase (step S21). As described above, the multiplication unit 144 estimates the fluctuation components of the phase shift by calculating the difference between the phase information symbol PI and the expected value decided by the first decision unit 143. When the multiplication unit 144 estimates the phase shift of the carrier phase, the averaging unit 145 averages the fluctuation components of the phase shift (step S22). Specifically, the averaging unit 145 calculates the average value of the fluctuation components of the phase shift.

After the averaging unit 145 performs averaging, the second determination unit 151 removes the phase shift of the carrier phase (step S23), and determines whether the type of the zone to which the phase information symbol PI is mapped is the second zone Z2 (step S24). When the zone is not the second zone Z2 (step S24: NO), the second decision unit 152 outputs, for example, the error information, and the process is terminated.

When the type of the zone to which the phase information symbol PI is mapped is the second zone Z2 (step S24: YES), the second decision unit 152 decides the transmission known phase information as the expected value (step S25). When the second decision unit 152 decides the expected value, the multiplication unit 153 executes the processing of the step S4, and the averaging unit 154, the interpolation unit 146, and the multiplication unit 147 execute the processing of step S5 and subsequent steps. In this way, even when the carrier phase is recovered using the first zone Z1, the second zone Z2, and the third zone Z3, the CPR 24 can stably restore the carrier phase of the signal on which the THP processing is executed.

For example, in each of the above described embodiments, the phase error of the carrier phase has been described as an example of an error of the present disclosure, but the error is not limited to the phase error of the carrier phase. The error in the present disclosure may be a waveform error such as fluctuation in polarization or polarization mode dispersion of the transmission lines 91 and 92.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical transmission system comprising:
a transmitter; and
a receiver that receives signal light transmitted from the transmitter via a transmission line;
wherein the transmitter includes:
a generator that generates a second digital signal including a first digital signal and a third signal, the first digital signal including a first signal corresponding to a pilot symbol and a second signal corresponding to a data signal, the third signal including information related to a carrier phase of the first signal after Tomlinson-Harashima Precoding (THP) processing is performed;
a THP processor that performs the THP processing on the second digital signal; and
a transmission circuit that transmits, to the transmission line, signal light generated based on a third digital signal which is a signal after the THP processing is performed on the second digital signal; and
wherein the receiver includes:
a reception circuit that receives the signal light from the transmission line; and
a compensator that compensates for an error of the second signal based on the first signal and the third signal, both of which are included in the third digital signal generated based on the signal light received by the reception circuit.

2. The optical transmission system according to claim 1,
wherein the first signal is a Quadrature Phase Shift Keying (QPSK) signal.

3. The optical transmission system according to claim 1,
wherein the receiver further includes an adaptive equalizer that adaptively equalizes the second signal based on a fourth signal after the compensator compensates for an error of the first signal based on the first signal and the third signal.

4. The optical transmission system according to claim 1,
wherein the compensator determines an amplitude and a phase of the third signal after the THP processing is executed, generates an expected value of the first signal based on a determination result, and estimates an error of the first signal based on the first signal and the expected value.

5. The optical transmission system according to claim 1,
wherein when the first signal and the third signal are independent of each other, the compensator includes a first compensator that compensates for an error of the first signal based on an M-th power method, where M is a number of modulation levels and a second compensator that compensates for a phase slip generated in the first compensator based on the third signal.

6. A transmitter that transmits signal light to a receiver via a transmission line, the transmitter comprising:
a generator that generates a second digital signal including a first digital signal and a third signal, the first digital signal including a first signal corresponding to a pilot symbol and a second signal corresponding to a data signal, the third signal including information related to a carrier phase of the first signal after Tomlinson-Harashima Precoding (THP) processing is performed;
a THP processor that performs the THP processing on the second digital signal; and
a transmission circuit that transmits, to the transmission line, signal light generated based on a third digital signal which is a signal after the THP processing is performed on the second digital signal.

7. The transmitter according to claim 6,
wherein the first signal is a Quadrature Phase Shift Keying (QPSK) signal.

8. The transmitter according to claim 6,
wherein the third signal has an amplitude smaller than a modulo amplitude of a modulo operator provided in the THP processor.

9. The transmitter according to claim 6,
wherein an amplitude of the first signal is a modulo amplitude of a modulo operator provided in the THP processor.

10. The transmitter according to claim 6,
wherein the third signal is arranged at a signal point farthest from a center of a coordinate plane on which the second signal is arranged.

11. The transmitter according to claim 6,
wherein the third signal is arranged at a signal point at which Euclidean distances from the second signal are equal in respective quadrants of a coordinate plane on which the second signal is arranged.

12. The transmitter according to claim 6,
wherein the second signal including the third signal is arranged based on a multi-level modulation method.

13. The transmitter according to claim 6,
wherein the THP processor periodically inserts a cancellation signal that cancels a change in the first signal immediately before the first signal.
